(19) United States
(12) Patent Application Publication
(10) Pub. No.: US 2006/0126908 A1
(43) Pub. Date: Jun. 15, 2006

(54) Fingerprint recognition method

(75) Inventors: Yun Shik Moon, Seongnam-si (KR); Taek Soo Kim, Goyang-si (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/298,036

(22) Filed: Dec. 9, 2005

(30) Foreign Application Priority Data
Dec. 9, 2004 (KR) 10-2004-0103312

(51) Int. Cl. G06K 9/00

(52) U.S. Cl. 382/125

(57) ABSTRACT

Disclosed is a fingerprint recognition method including extracting ridge information of an inputted fingerprint and determining an identity between the inputted fingerprint and a reference fingerprint by comparing the ridge information of the inputted fingerprint with the ridge information of the reference fingerprint using distance variations between adjacent ridges.

This application claims the benefit of the Korean Patent Application No. 10-2004-0103312, filed on Dec. 9, 2004, which is hereby incorporated by reference as if fully set forth herein.

### BACKGROUND OF THE INVENTION

1. Field of the Invention

The present invention relates to a fingerprint recognition method.

2. Description of the Related Art

Generally, a fingerprint is a swirling ridge formed by protrusion of the sweat glands. A protruded swirling portion is called a ridge and a recessed swirling portion is called valley. The fingerprint is unique to each person and is not changed all his/her life.

Therefore, the fingerprint recognition method has been used as an effective personal identification method since it has relatively high reliability, stability and process speed compared with other recognition methods such as retina, iris, and face recognition methods.

In recent years, personal information security has been getting important, as electronic-commerce and credit-commerce have been increased. Therefore, all eyes in the personal information security field have been centered upon a biometric technology development using the fingerprint.

A typical fingerprint recognition system has a fingerprint input sensor for capturing a fingerprint image, a feature point extracting unit for extracting feature points from the fingerprint image, and a comparison unit for determining if the fingerprint is identical to a reference fingerprint by comparing the feature points with those of the reference fingerprint.

That is, most of identification methods using the fingerprint recognition system are to compare the feature points extracted from the fingerprints with each other. The extraction process for the feature points is most important process for the personal identification and it takes a long time to perform the extraction process.

A typical fingerprint recognition process includes a feature point extraction process and a feature point adjustment process.

As the feature point extraction process, a thinning method is used. That is, relatively broad lines in the ridge pattern of the fingerprint image are thinned to reduce a measuring amount and effectively analyze. The thinning method is classified into a repeated pixel removing method and a non-repeated pixel removing method.

Since the former is to thin the fingerprint image by consecutively removing unnecessary pixels in the overall finger print image, a relatively large amount of memory capacity is required and the process time is retarded. That is, it takes a long time to identify a user.

On the contrary, the latter is a fingerprint ridge tracking method that can be done without large amount of memory capacity. Therefore, since a relatively large amount of information can be used, the latter is estimated to be superior to the former in terms of the recognition speed and noise removal.

In the fingerprint ridge tracking method, noise is removed from a fingerprint image inputted through a fingerprint input system and a pretreatment process for adjusting the fingerprint image whose noise is removed to a predetermined gray level value is done. Then, feature points such as an ending point and a bifurcation point are extracted by tracking the ridge flow in the gray level image.

Then, after feature points formed by the noise are removed from the extracted feature points, a similarity is calculated through a matching process with a pre-registered fingerprint to determine identification of the fingerprint. Therefore, a complicated and time-consuming problem due to the conventional binary coding and thinning processes can be solved.

Both of the repeated pixel removing method and the non-repeated pixel removing method are designed to recognize the fingerprint based on the feature points of the fingerprint. Therefore, when accurate feature points cannot be obtained from the fingerprint inputted, the accurate fingerprint recognition cannot be realized.

FIGS. 1 and 2 show examples that may cause fingerprint recognition errors when the fingerprint recognition is performed based on the feature points of the fingerprint.

FIG. 1 shows a case when the inputted fingerprint is damaged or the fingerprint is unstably inputted. In this case, since many erroneous feature points are extracted from the inputted fingerprint of a person, his/her inputted fingerprint may be determined as a fingerprint that is not identical to a his/her registered fingerprint.

FIG. 2 shows a case when the number of feature points of the fingerprint, which can be extracted from the inputted fingerprint, is reduced since the inputted fingerprint corresponds a part of the overall fingerprint. In this case, since the number of feature points that can be compared with the registered genuine fingerprint information is too small, a rejection rate of the right person is increased.

As described above, the feature-point-based fingerprint recognition method has a limitation in accurately recognizing a fingerprint since it is difficult to extract accurate feature points from the fingerprint when the fingerprint is damaged, the fingerprint input is unstable, the inputted fingerprint corresponds only a part of the overall fingerprint, the ridges of the fingerprint are cut by the user's pressure pattern, or the like.

### SUMMARY OF THE INVENTION

Accordingly, the present invention is directed to a fingerprint recognition method that substantially obviates one or more problems due to limitations and disadvantages of the related art.

An object of the present invention is to provide a fingerprint recognition method that can accurately perform the fingerprint recognition even for fingerprint information on damaged fingerprints or partly inputted fingerprint.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a fingerprint recognition method including: extracting ridge information of an inputted fingerprint; and determining an identity between the inputted fingerprint and a reference fingerprint by comparing the ridge information of the inputted fingerprint with the ridge information of the reference fingerprint using distance variations between adjacent ridges.

In another aspect of the present invention, there is provided a fingerprint recognition method including: inputting a fingerprint; pre-treating the inputted fingerprint by extracting ridge information from the inputted fingerprint and storing the extracted ridge information; and matching the inputted fingerprint with a reference fingerprint to determine if the inputted fingerprint is identical to the reference fingerprint from the ridge information of the inputted fingerprint according to a distance variation between the inputted fingerprint and the reference fingerprint.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1 and 2 are views illustrating examples that may cause fingerprint recognition errors when the fingerprint recognition is performed based on feature points of a fingerprint;

FIG. 3 is a flowchart illustrating a pretreatment process for extracting feature points of a fingerprint in a fingerprint recognition method according to an embodiment of the present invention;

FIG. 4 is a flowchart illustrating a matching process for matching an inputted fingerprint with a reference fingerprint in a fingerprint recognition method according to an embodiment of the present invention;

FIG. 5 is a view illustrating a fingerprint recognition result when an identical fingerprint is erroneously aligned in a fingerprint recognition method according to an embodiment of the present invention;

FIG. 6 is a view illustrating a fingerprint recognition result when there is a displacement in an identical fingerprint in a fingerprint recognition method according to an embodiment of the present invention;

FIG. 7 is a view illustrating a fingerprint recognition result between a reference fingerprint and a different fingerprint in a fingerprint recognition method according to an embodiment of the present invention; and

FIG. 8 is a view illustrating a fingerprint recognition result for a reference fingerprint and a different fingerprint in a fingerprint recognition method according to an embodiment of the present invention.

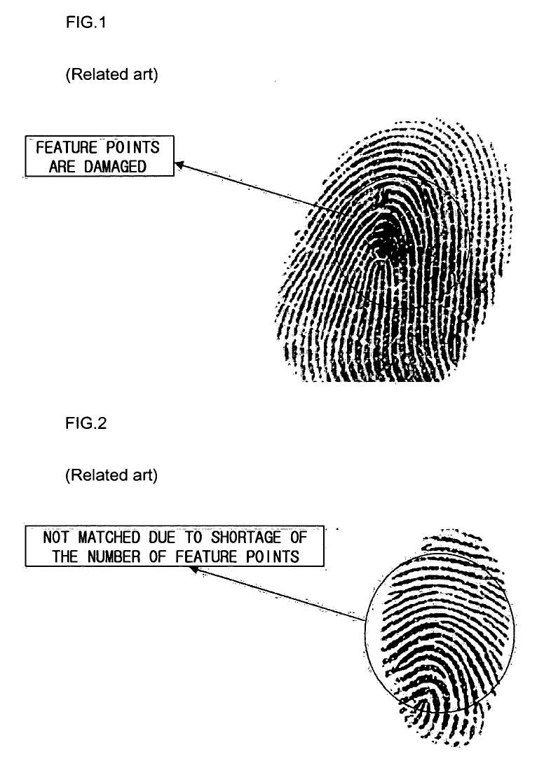

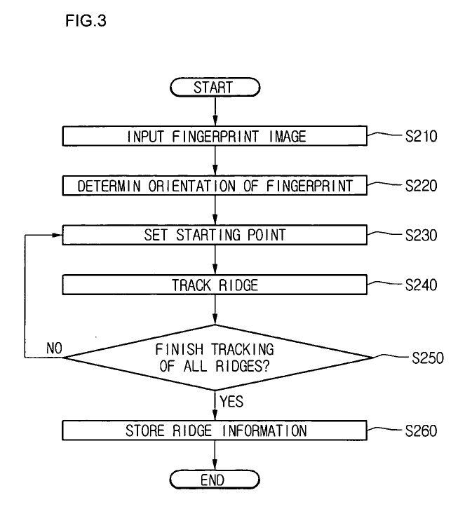

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

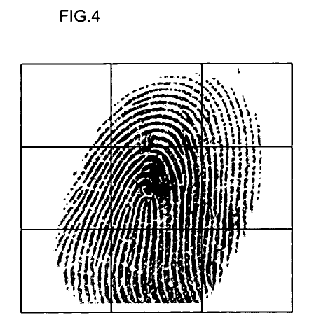

FIG. 3 is a flowchart illustrating a pretreatment process for extracting feature points of a fingerprint in a fingerprint recognition method according to an embodiment of the present invention.

Referring to FIG. 3, fingerprint ridge information is extracted from a fingerprint image and stored. This will be now described in more detail.

When a fingerprint image is inputted (S210), an orientation of the fingerprint is determined to obtain information required for recognizing the fingerprint from the inputted fingerprint image (S220).

In addition, as shown in FIG. 4, to effectively detect ridge information on the inputted fingerprint, the inputted fingerprint image is divided into a plurality of blocks each having a predetermined size and the ridge information on each block is detected. To realize this, a starting point for tracking the ridge is first determined (S230).

In order to detect the ridge information from the starting point determined in the process S230, the ridges are tracked and the ridge information is stored.

That is, a ridge tracking is performed from the starting point of each block (S240). In the ridge tracking, the tracking is performed for all of the ridges extending from the starting point of the selected block.

All of the ridges extending from the starting point are found by tracking a subject ridge using the starting point found in the subject block and location information, orientation information, and information required for the number of ending points of the ridge, a coordinate value of the ending points, bifurcation points of the ridge, and a coordinate value of the bifurcation.

At this point, when the tracking is performed for interconnected ridges, former tracking information is used to determine a next tracking point. In order to find an actual ridge from the next tracking point, the fingerprint image is sampled in a direction perpendicular to the tracking direction. An actual ridge location is found from edge information of the sampled imaged.

When the ridge tracking for the subject block is finished, it is determined if the ridge tracking is finished for the all of the blocks of the inputted fingerprint image (S250).

When it is determined that the ridge tracking is finished for the all of the blocks, the ridge information detected through the ridge tracking is stored (S260) and the pretreatment process is ended.

However, when it is determined that the ridge tracking is not finished for the all of the blocks, the process for determining the starting point of the next block (S230) is performed again to perform the ridge tracking process for the next block.

Meanwhile, in the fingerprint recognition method of the present invention, the determining process (S250) may be performed after the ridge information storing process (S260) is performed.

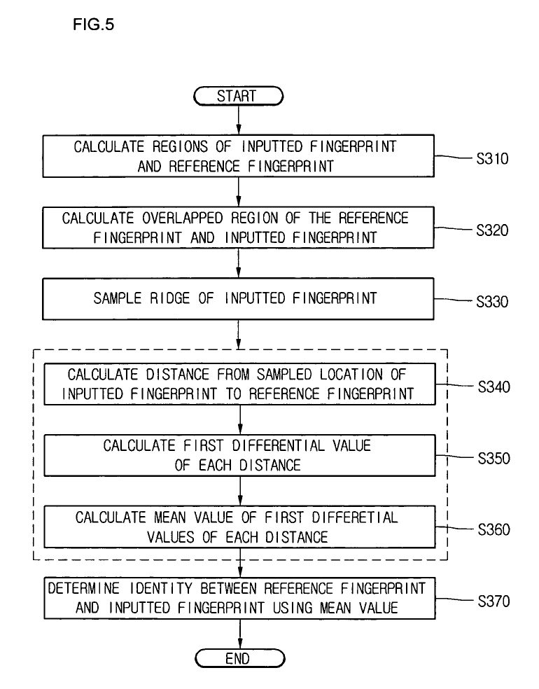

FIG. 5 is a view illustrating a fingerprint recognition result when an identical fingerprint is erroneously aligned in a fingerprint recognition method according to an embodiment of the present invention.

In the present invention, the reference fingerprint means a fingerprint that is registered or stored in advance and the inputted fingerprint means a fingerprint that is newly inputted to be compared with the reference fingerprint.

Referring to FIG. 5, a matching process between the reference fingerprint and the inputted fingerprint is performed by aligning the reference fingerprint and the inputted fingerprint and overlapping the same one another (S310) and (S320).

In addition, in order to detect information on a distance difference between the reference fingerprint and the inputted fingerprint, a ridge of a predetermined portion of the inputted fingerprint is sampled (S330).

Then, a distance from a sampled location of the inputted fingerprint and a ridge of the reference fingerprint, which is closest to the sampled location, is calculated (S340). That is, a distance from a first ridge of the inputted fingerprint to a first ridge of the reference fingerprint, which is closest to the first ridge of the inputted fingerprint, is calculated. At this point, the inputted fingerprint has a coordinate value that is detected during the sampling process S330.

Meanwhile, since the reference fingerprint and the inputted fingerprint may be exactly aligned with each other and the fingerprint may be damaged, the distanced calculated by the above process is not the accurate value. To solve this problem, there is a need to compare the flows of the ridges of the fingerprints with each other.

Therefore, a distance variation from the inputted fingerprint to the reference fingerprint is calculated using the distance between the inputted fingerprint and the reference fingerprint. Here, the distance variation is used as a first differential value (S350).

At this point, when the distance variation is less than a preset reference value, it is determined that the inputted fingerprint is identical to the reference fingerprint. On the contrary, when the distance variation is higher than the preset reference value, it is determined that the inputted fingerprint is different from the reference fingerprint.

Meanwhile, in order to improve the reliability of the fingerprint recognition, a mean value of the first differential values is used as a fingerprint determining reference of the person himself/herself and another person. Therefore, the mean value of the first differential values is calculated (S343).

When the mean value of the distance variations, which is represented as the mean value of the first differential values, is less than a predetermined value, it is determined that the inputted fingerprint is identical to the reference fingerprint. When the mean value of the distance variations, which is represented as the mean value of the first differential values, is greater than the predetermined value, it is determined that the inputted fingerprint is different from to the reference fingerprint (S350).

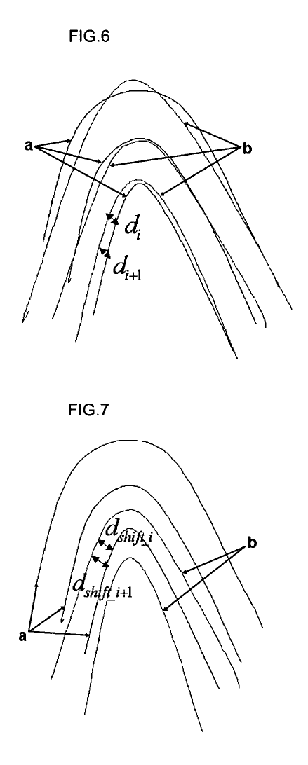

FIGS. 6 through 8 shows an example for determining identity between the inputted fingerprint and the reference fingerprint.

In the drawings, the reference characters “a” and “b” respectively indicate a ridge of the inputted fingerprint and a ridge of the reference fingerprint.

The mean value of the first differential values is represented as “Score.” When the Score is low, it is determined that the reference fingerprint and the inputted fingerprint are recognized as a fingerprint of an identical person. When the Score is high, it is determined that the reference fingerprint and the inputted fingerprint are recognized as fingerprints of different persons.

FIG. 6 is a view illustrating a fingerprint recognition result when there is a displacement in an identical fingerprint in a fingerprint recognition method according to an embodiment of the present invention.

As shown in FIG. 6, when the identical fingerprints are well aligned one another, both of a distance di at a sampled location i and a distance dᵢ₊₁ at a sample location i+1 have a relatively low value.

Therefore, the Scoreₙₒᵣₘₐₗ representing a mean value of the variations of the distances expressed by the following equation 1 has a relatively low value.

$${Score}_{normal} = \frac{1}{n - 1} {\sum }_{i = 1}^{n - 1} ( {d}_{i + 1} - {d}_{i} ) \qquad [ Equation 1 ]$$

FIG. 7 is a view illustrating a fingerprint recognition result between a reference fingerprint and a different fingerprint in a fingerprint recognition method according to an embodiment of the present invention.

As shown in FIG. 7, when there is a variation between identical fingerprints, this means that the identical fingerprint images are shifted. In this case, the distance increases but an amount of the distance increase between adjacent points similarly appears.

Therefore, the distance di at the sampled location i and the distance dᵢ₊₁ at the sample location i+1 have values similar to each other.

Accordingly, the Score_{shift} representing a mean value of the variations of the distances expressed by the following equation 2 has a relatively low value.

$$\begin{matrix}{Score}_{shift} = \frac{1}{n - 1} {\sum }_{i = 1}^{n - 1} ( {d}_{shift i + 1} - {d}_{shift j} ) \\ \approx \frac{1}{n - 1} {\sum }_{i = 1}^{n - 1} ( ( {d}_{i + 1} + {d}_{shift} ) - ( {d}_{i} + {d}_{shift} ) ) \\ \approx \frac{1}{n - 1} {\sum }_{i = 1}^{n - 1} ( {d}_{i + 1} - {d}_{i} ) = {Score}_{normal}\end{matrix} \qquad [ Equation 2 ]$$

In addition, even when the inputted finger print image rotates relative to the reference fingerprint image, a distance difference between the adjacent sampled locations increases. However, in the case where the sampling rate is set to be low, the final calculation result is low even when the inputted fingerprint image rotates slightly. The Scoreᵣₚₜ representing a mean value of the variations of the distances expressed by the following equation 3 has a relatively low value.

$$\begin{matrix}{Score}_{rot} = \frac{1}{n - 1} {\sum }_{i = 1}^{n - 1} ( {d}_{rot j + 1} - {d}_{rot j} ) \\ \approx \frac{1}{n - 1} {\sum }_{i = 1}^{n - 1} ( ( {d}_{i + 1} + {d}_{rot j + 1} ) - ( {d}_{i} + {d}_{rot j} ) ) \\ \approx \frac{1}{n - 1} {\sum }_{i = 1}^{n - 1} ( {d}_{i + 1} - {d}_{i} ) = {Score}_{normal}\end{matrix} \qquad [ Equation 3 ]$$

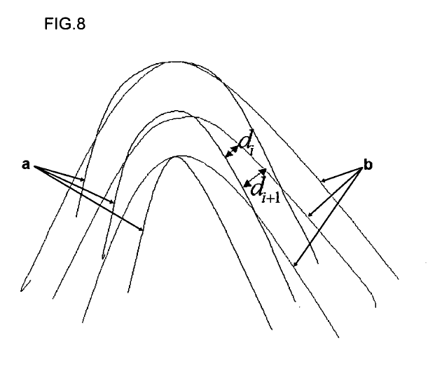

FIG. 8 is a view illustrating a fingerprint recognition result for a reference fingerprint and a different fingerprint in a fingerprint recognition method according to an embodiment of the present invention.

As shown in FIG. 8, when the inputted fingerprint is a fingerprint of a different person, the distance di at the sampled location i and the distance dᵢ₊₁ at the sample location i+1 are different from each other. Therefore, The Score_{different-finger} representing a mean value of the variations of the distances expressed by the following equation 4 has a relatively high value.

$${Score}_{different finger} = \frac{1}{n - 1} {\sum }_{i = 1}^{n - 1} ( {d}_{i + 1} - {d}_{i} ) \qquad [ Equation 4 ]$$

As described above, the mean value of the first differential values of the distances between the referent fingerprint and the inputted fingerprint at the sample location is used. Therefore, even when there is a slight shift or rotation between the inputted fingerprint and the reference fingerprint, since the calculated Score is low when the inputted fingerprint is identical to the reference fingerprint, the identity between the inputted fingerprint and the reference fingerprint can be effectively detected.

According to the above-described present invention, as the fingerprint ridge-based recognition method, even when the feature points are damaged or the number of the feature points is small, the identity between the inputted fingerprint and the reference fingerprint can be effectively determined.

Accordingly, when the fingerprint recognition method of the present invention is applied to fingerprint recognition products, the recognition rate can be improved.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A fingerprint recognition method comprising:
extracting ridge information of an inputted fingerprint; and
determining an identity between the inputted fingerprint and a reference fingerprint by comparing the ridge information of the inputted fingerprint with the ridge information of the reference fingerprint using distance variations between adjacent ridges.

2. The fingerprint recognition method according to claim 1, further comprising determining an orientation of the inputted fingerprint to extract the ridge information of the inputted fingerprint.

3. The fingerprint recognition method according to claim 1, wherein the inputted fingerprint is divided into a plurality of blocks and the ridge information is extracted at each block.

4. The fingerprint recognition method according to claim 3, wherein a start point is extracted from each block and a ridge extending from the starting point is tracked.

5. The fingerprint recognition method according to claim 1, wherein the comparing the ridge information is performed by comparing a first ridge of the inputted fingerprint with a first ridge of the inputted fingerprint, which is closest to the first ridge of the inputted fingerprint.

6. The fingerprint recognition method according to claim 1, wherein a mean value of the distance variations is compared with a predetermined value, and when the mean value is lower than the predetermined value, it is determined that the inputted fingerprint is identical to the reference fingerprint.

7. A fingerprint recognition method comprising:
inputting a fingerprint;
pre-treating the inputted fingerprint by extracting ridge information from the inputted fingerprint and storing the extracted ridge information; and
matching the inputted fingerprint with a reference fingerprint to determine if the inputted fingerprint is identical to the reference fingerprint from the ridge information of the inputted fingerprint according to a distance variation between the inputted fingerprint and the reference fingerprint.

8. The fingerprint recognition method according to claim 7, wherein the pre-treating the inputted fingerprint comprises:
determining an orientation of the inputted fingerprint;
dividing the inputted fingerprint into a plurality of blocks;
setting a starting point for tracking the ridge;
storing the ridge information by tracking the ridge from the starting point.

9. The fingerprint recognition method according to claim 8, wherein the string the ridge information comprises:
storing information of the ridge extending from the starting point of a selected block; and
storing, when the ridges extending from all of starting points of selected blocks are tracked, information of the ridge extending from a starting point of another block.

10. The fingerprint recognition method according to claim 7, wherein the matching the inputted fingerprint comprises:
aligning the inputted fingerprint with the reference fingerprint;
sampling ridge points from the first ridge of the inputted fingerprint at a predetermined distance; and
calculating a shortest distance from the ridge points to the ridge of the reference fingerprint.

11. The fingerprint recognition method according to claim 7, further comprising comparing a mean value of the distance variations with a predetermined reference value.
